(19) United States
(12) Patent Application Publication
(10) Pub. No.: US 2017/0276762 A1
(43) Pub. Date: Sep. 28, 2017

(54) GEOSPATIAL LOCATION VERIFICATION

(71) Applicant: Thandisizwe Ezwenilethu Pama, Sandton (ZA)

(72) Inventor: Thandisizwe Ezwenilethu Pama, Sandton (ZA)

(21) Appl. No.: 15/518,558

(22) PCT Filed: Oct. 14, 2015
(86) PCT No.: PCT/IB2015/057883

§ 371 Date: Apr. 12, 2017

(30) Foreign Application Priority Data
Oct. 29, 2014 (ZA) 2014/07876

(51) Int. Cl. G01S 5/02; H04L 29/06; H04W 4/02; H04W 88/08; G06F 17/30

(52) U.S. Cl. CPC G01S 5/0289; H04W 88/08; G06F 17/30041; H04W 4/02; H04L 29/06

(57) ABSTRACT

This invention provides a location verification server and a geospatial database in which is stored identity and geospatial location data pertaining to network elements (for instance GSM towers and base station transceivers (BTS)) and transaction devices (such as POS terminals). When a transaction is initiated on a transaction device, a location verification request is transmitted to the location verification server which is programmed to: communicate with 106 the mobile network of the mobile device associated with the transaction to determine the identities of network elements located in the vicinity of the mobile device; to perform a lookup in the geospatial database to determine the stored geospatial locations of the identified network elements and the originating transaction device; and to compare the locations of the transaction device and network elements to confirm location of the mobile device.

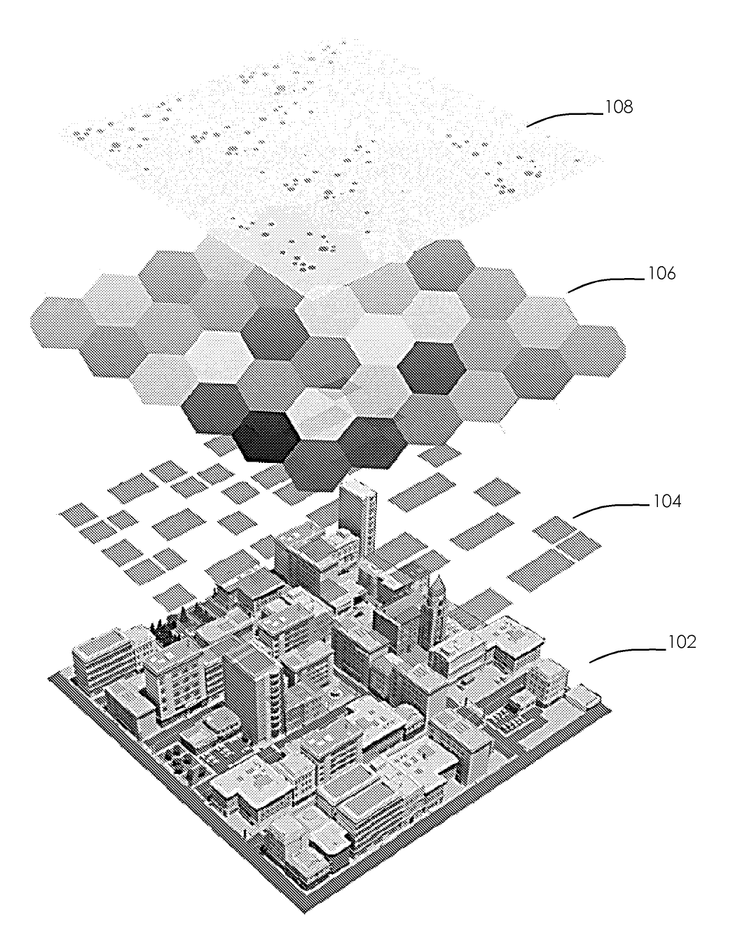

### FIELD OF THE INVENTION

This invention relates generally to location-based services in mobile (cellular) communication networks.

### BACKGROUND TO THE INVENTION

Location verification in financial services, payments- and related industries conventionally makes use of mobile-based, network-based, GPS or related location services that use various methods of locating the mobile device, including mobile network equipment and WI-Fi and Bluetooth transceivers.

These technologies serve their purpose adequately in situations where location verification is not a time sensitive requirement. However, in time sensitive systems or applications, where the time lapse between the mobile location request and the location response needs to be of the order of fractions of a second (typically milliseconds to microseconds and preferably less), current technologies and services are inadequate. Current technologies are unable to deliver a high speed location service capable of meeting the time sensitive requirements of such applications and systems.

The problem is exacerbated in location-based multi-channel authentication or authorisation situations which require real-time comparison of mobile device location with the location of an activity which is initiated by or associated with the mobile device. In these situations, typically, device location is determined on a first (verification) channel using current location verification technologies and the activity is undertaken on a second (transaction) channel, which typically, is an internet channel, a POS or Service Access Device, an ATM or a similar high-speed channel. In these situations in particular, location verification in the first channel tends to lag behind transaction processing in the second channel, with the resultant delays being greater than would be expected from a true real-time transaction processing system.

This is because the current technologies are essentially in-transaction technologies that commence the location determination process at the moment the location determination requirement becomes apparent, typically when a transaction or service is requested, and then implement the entire location determination process in parallel with the transaction or service—essentially within the transaction. Real-time location verification is data- and computation-intensive, hence it is a time consuming process and not particularly suited to real-time implementation commencing only at the inception of a time sensitive service.

This invention seeks to address this shortcoming.

### SUMMARY OF THE INVENTION

According to this invention, a method of locating a mobile communication device comprises:
in a preparatory process, the step of recording, in a network element data store, data pertaining to a plurality of network elements constituted by communication devices capable of communicating with the mobile device in a device location process, including the identity and geospatial location of each network element; and
in a process of locating the mobile communication device, the steps of:
   communicating, from the mobile device, with one or more network elements located in the vicinity of the mobile device;
   determining the identity of each such network element; and
   looking up, in the network element data store, the geospatial location of each identified network element, thereby to locate the mobile communication device in the vicinity of the network element.

A “network element” is any communications-enabled device capable of communicating with the mobile device. The primary network elements used in the system of the invention are constituted by core mobile network transceiver apparatus, including cell phone towers and base transceiver stations (BTS) which have known or knowable identities, geographic locations and location-specific characteristics, all of which can be recorded in the network element database. The BTS is sometimes referred to as a base station (BS), radio base station (RBS) or node B (eNB). The network may be any wireless technology, like Code Division Multiple Access (CDMA), Global System for Mobile Communications (GSM), Worldwide Interoperability for Microwave Access (WiMAX) or Wi-Fi. A BTS is associated with mobile communications technologies and essentially constitutes the apparatus that creates the “cell” in a cellular network. Sometimes, an entire base station, plus its tower are improperly referred to as a BTS. The function of the BTS remains the same—no matter what type of wireless technology is used.

For purposes of the device location process, the step of communicating from the mobile device with network elements is standard operating procedure—network protocols require the mobile device repeatedly to query its location relative to network elements. These communications therefore do not constitute in-transaction communication to or from the mobile device and, once the location of the device relative to a network element or elements is known, the rest of the location process is undertaken simply by lookup in the data store.

The method of locating the mobile device may include the steps of:
in a supplemental preparatory process, recording, in a transaction device data store, data pertaining to a plurality of transaction devices constituted by devices capable of conducting financial transactions, including the identity and geospatial location of each transaction device;
in response to a location verification request originating from a transaction conducted on a transaction device, implementing a location process including the steps of:
   determining the identity of the originating transaction device;
   looking up, in the transaction device data store, the geospatial location of the originating transaction device;
   querying the network to determine the identity of one or more network elements located in the vicinity of the mobile device;
   determining the identity of each such network element;
   looking up, in the network element data store, the geospatial location of each identified network element; and
   comparing the geospatial location of the transaction device, with the geospatial location of the mobile device, as determined in the first location process.

In the preferred embodiment of the invention, the geospatial location data pertaining to the network elements and the transaction devices is stored in a digital mesh format. The simplest map mesh formats are digital grids, but in the preferred form of this embodiment of the invention, the geospatial location data is stored in a polygon mesh format.

In this form of the invention, the method may conveniently include the specific steps of
determining the location of the originating transaction device with reference to a map mesh polygon;
digitally locating the mobile device in a map polygon with reference to network elements in the vicinity of the mobile device; and
determining the proximity or otherwise of the map polygons of the originating transaction device and the mobile device.

If the map polygons overlap or are within a predetermined proximity, it can be assumed that the mobile communication device is within a predetermined vicinity of the originating transaction device, thereby providing location verification that is sufficiently exact to assist in authorising and authenticating most financial transactions.

The advantage of using a polygon mesh format is that it provides a “shorthand” means of describing location, since map polygons typically require fewer descriptors than normal geographic notation to describe and locate each map polygon, thereby providing an exceptionally rapid locational notation and retrieval system.

The invention includes a system for locating a mobile communication device, the system comprising:
a network element data store containing data pertaining to a plurality of network elements constituted by communication devices capable of communicating with the mobile device in a device location process, including data pertaining to the identity and the geospatial location of each network element;
means to determine the identity of each such network element; and
programmable logic means programmed to look up, in the data store, the geospatial location of each identified network element thereby to locate the mobile communication device in the vicinity of the network element.

The system may conveniently include, in the network element data store, data pertaining to supplemental network elements, such as Wi-Fi access points, beacons and any other radio frequency devices that have known, recordable locations and that are capable of communication with the network and devices in communication with the network. The network elements will be referred to herein as “supplemental network elements”.

The system may conveniently include a transaction device data store containing data pertaining to a plurality of transaction devices, including data pertaining to the identity and the geospatial location of each transaction device, the system programmable logic means being programmed:
to receive a location verification request originating from a transaction conducted on a transaction device;
on receipt of a location verification request, to determine the identity of the originating transaction device;
to look up, in the transaction device data store, the geospatial location of the originating transaction device; and
to compare the geospatial location of the transaction device with the geospatial location of each identified network element thereby to locate the mobile communication device.

The data is saved in the data store ahead of any activity requiring mobile device location so that, at the time of the activity, instead of attempting to locate either or both the mobile device and the activity, the process outlined above simply requires a data store location lookup based on location information of the network elements in communication with the mobile device at the time of the activity, thereby locating the mobile device in the vicinity of such network elements, the locations of which are stored in the data store.

In the preferred form of this embodiment of the invention, the system programmable logic means is programmed to store the geospatial location data pertaining to the network elements and the transaction devices in a digital map in a polygon mesh format, the programmable logic means being programmed, further, to determine the location of an originating transaction device with reference to a map polygon, digitally to locate the mobile device in a map polygon with reference to network elements in the vicinity of the mobile device and to determine the proximity or otherwise of the map polygons of the originating transaction device and the mobile device.

### BRIEF DESCRIPTION OF THE DRAWINGS

The invention will be further described with reference to the accompanying drawing which is a diagrammatic illustration of the data elements within a layered geospatial database according to the invention.

### DESCRIPTION OF EMBODIMENTS OF THE INVENTION

Service and transaction processing requirements in the financial services industry and in the payment- and related industries are time sensitive in that the time lapse between service initiation and service completion is critical. Where location-based services are introduced into these processes, any mobile device location request and response needs to be of the order of fractions of a second (typically milliseconds to microseconds and preferably less). Current technologies and location services are unable to deliver service with sufficient speed to meet the time sensitive requirements of these applications or systems.

This is because of a fundamental shortcoming in current technologies, which are configured to undertake the entire location determination process in real transaction time, with the location determination process commencing only at the moment the device location is requested. However, the processing time requirement of the current process, which is computation- and communication intensive, exceeds the processing time requirements of most time sensitive transactions and services.

The shortcoming is exposed in multi-channel authentication or authorisation situations in which a transaction, service or activity is undertaken on a high-speed channel, typically referred to as a second channel and typically constituted by an internet channel, a POS or Service Access Device, an ATM or the like. In these situations in particular, current location verification technologies or processes undertaken on the mobile communications channel tend to take longer than activity processing on the second channel, thereby giving rise to actual or apparent delays greater than would be expected from a true real-time transaction processing system.

As indicated, the shortcoming identified by this invention is the fact that current technologies and processes undertake and implement the entire location determination process in real transaction time, with the location determination process commencing only at the moment the device location is requested.

The solution, according to this invention, is to provide a system and processes or methods for undertaking and implementing as many parts of the device location process prior to a location verification request being issued.

According to the invention, this is done by the provision of a pre-configured network element data store or database that constitutes the digital equivalent of a geospatial map that records and stores the geographic locations of a plurality of network elements.

For finer granularity of location data, the network elements may conveniently include supplemental network elements, such as Wi-Fi access points, mobile network beacons and any other network-connected radio frequency devices with known or knowable identities, geographic locations and location-specific characteristics that can be recorded in the network element database. For instance, Wi-Fi access points publicly broadcast data that include identification and location data specific to the Wi-Fi access point.

In one implementation of the system and methods of the invention, the network element database is supplemented by a data store or database of transaction devices.

The data stores or databases (the network element database and the transaction device database) may conveniently be implemented on a single computer and whether this is done or not, the computer or computers hosting the network element database and the transaction device database will be referred to in this specification as the “geospatial database computer” and the database or databases, singly or in combination, will be referred to as the “geospatial database”.

For purposes of this specification, a “transaction device” is any transaction-capable digital or electronic device with which the mobile device can interact during transaction processing and which has a known or knowable identity, geographic location and location-specific characteristics that can be recorded in the transaction device database. “Transaction-capable” means that a transaction, particularly a financial transaction can be undertaken with the use of the device. Examples of transaction devices include ATMs and POS terminals.

The mobile device location process of the invention is typically implemented when transaction activity occurs that requires authentication of the person initiating the transaction and authorisation of the transaction. In both of these processes—authentication and authorisation, a determination of the location of the mobile device of the person initiating the transaction serves to enhance the fidelity of the authentication and authorisation process.

When a transaction is initiated on a transaction device, for instance a POS terminal using a credit card (as a non-limiting examples), the transaction is initiated on the transaction device channel (a communications channel extending between the transaction device and the financial institution supporting the transaction device). Financial processing of the transaction is implemented on a first channel, the transaction device channel between the POS terminal and the financial institution, in which transaction authentication is processed—verification of bank account details, bank balances and availability of funds. At the same time, a second, parallel authentication and authorisation process is implemented on a second (mobile device) channel. In this second process, authentication of the mobile device and mobile device user are used as a means of authenticating the identity of the person initiating the transaction. In addition, the initiating person's mobile device can be used as a parallel communications channel to authorise the transaction.

It is within this second (parallel) process that the device location process of the invention is implemented to enhance the fidelity of the authorisation/authentication process.

Using the system and methods of the invention, a location verification server is included in the authorisation/authentication system and process. The location verification server is a network-connected computer which is in communication with the computers of mobile network operators and the geospatial database computer. In certain implementations of the system of the invention, the location verification server and the geospatial database computer may be one and the same computer.

Initiation of the transaction on the transaction device channel, besides triggering first- and second-channel authentication, also triggers a location verification request to the location verification server. The location verification request pertains to the then current location of the mobile device associated with the transaction—such association will have been created in a prior registration process in which the transaction instrument (for instance a credit card), the user of the transaction instrument and a mobile device of the user that is to be associated with the transaction instrument, are registered on the system.

The location verification server is programmed, on receipt of such a mobile device location request, to implement a device location process in which the geospatial location of the mobile device associated with the transaction (transaction instrument) is determined.

The first step in the mobile device location process is a network element identification step. In this step, the location verification server first communicates with the mobile network with which the mobile device is associated to determine the current status of the mobile device and communications exchanged between the mobile device and the network element or elements located in the vicinity of the mobile device. In this first step the location verification server requires the mobile network operator to supply no data other than the identity of each such network element.

The second step in the mobile device location process is a database lookup step. In this step, the location verification server communicates the network element identity data to the geospatial database computer which is programmed to look up the geospatial location of each network element identified in the network element identification step—essentially network elements located in the vicinity of the mobile device at that time, as identified in the network element identification step.

This will serve rapidly to locate the mobile communication device in the vicinity of one or more network elements, thereby providing location verification that is sufficiently exact to assist in authorising and authenticating most financial transactions.

As indicated above, the geospatial database may include a transaction device data store or database. In such a supplemented system, the mobile device location process may include a supplemental location verification process. In this process, the location verification server communicates with one or all of the following: the originating transaction device—the transaction device that initiates the transaction and transmits the location verification request to the location verification server; a mobile network, if any, in communication with the transaction device; and a financial institution, if any, in communication with the transaction device. The purpose of this communication is merely to determine the identity and current status of the originating transaction device. In this step, the location verification server requires no data other than the identity and transaction status of the originating transaction device, that is whether or not the transaction device is currently engaged in a transaction and if so, whether the transaction is the transaction that gave rise to the mobile device location verification request currently in process on the location verification server.

Having determined the identity of the originating transaction device, the location verification server communicates the transaction device identity data to the geospatial database computer, which is programmed to look up the geospatial location of the originating transaction device.

This will allow rapid comparison of the location of the originating transaction device and, with reference to the network elements, also the location of the mobile communication device. If such comparison confirms location of the mobile device in the vicinity of the relevant transaction device, this will enhance the location verification of the previous process.

A practical implementation of the invention is illustrated in the drawing in diagrammatic form. In the drawing, the geospatial database is implemented on the geospatial database computer and structured with a database architecture resembling a layered geospatial location database. This format permits of rapid sequential geospatial location determination during a mobile device location process.

In the geospatial database, the data layers relate to:
102—a landscape layer: a digital map of the terrestrial landscape
104—a transaction device layer: the geographic locations of transaction devices
106—a network layer: the geographic locations of network elements—which data may include data pertaining to BTS coverage and signal characteristics

In the drawing, a hypothetical layer 108 is overlaid over the database structure diagrammatically to illustrate a plurality of locations that a mobile device and therefore a user associated with the device may physically occupy. The occupation points illustrated in the layer 108 do not constitute data stored in the database.

The data stored in the geospatial database is recorded and updated continuously, ahead of any activity requiring mobile device location. This means the geospatial database is ready for use at all times, so that, at the time of an activity requiring mobile device location, instead of attempting to locate either or both the mobile device and the activity, the process outlined above simply requires a database lookup based on location information of the activity and of the network elements in communication with the mobile device at the time of the activity, thereby locating the mobile device in the vicinity of such network elements, the locations of which are stored in the database.

In the geospatial database, the data in the transaction device layer 104 and the network layer 106 are stored in a polygon mesh format—essentially a digital mesh map in which the map polygons are fully described with the use of no more than two descriptors representing a longitudinal and a latitudinal description unique to that map polygon. This allows rapid locational notation and referencing of the geospatial location of the network elements (in the layer 106) and transaction devices (in the layer 104). It will be appreciated that this also allows rapid retrieval of such data.

Upon initiation of an activity requiring location determination, the mobile device associated with the activity is first located relative to the network layer 106. This is done using existing network functionality, for instance by location of the mobile device relative to one or more network elements such as cell towers, a process that runs continuously in background within normal mobile network systems. This determination is processed by the location verification server. In practice, the location verification server requests and obtains the location information from the mobile network. This step serves to locate the mobile device.

The activity is initiated on a transaction device that is identified to the geospatial database computer upon initiation of the activity. The transaction device is located relative to the transaction device layer 104. In this layer, the geospatial location of the transaction device is recorded in the geospatial database and a simple lookup is required to determine the geospatial location of the transaction device on which the activity has been initiated. This step serves to locate the activity.

For purposes of the subsequent verification process, the geospatial database computer runs a simple comparison between the mobile device and the activity location to determine whether the activity location is within an acceptable distance of the device location.

Once again, this determination is processed by the geospatial database computer.

Using a digital mesh map, the originating transaction device is located with reference to a map polygon. The mobile device is located with reference to a map polygon, using network elements in the vicinity of the mobile device. The location verification server is programmed simply to determine the proximity or otherwise of the map polygons of the originating transaction device and the mobile device. If the map polygons overlap or are within a predetermined proximity, it can be assumed that the mobile communication device is within a predetermined vicinity of the originating transaction device, thereby providing location verification that is sufficiently exact to assist in authorising and authenticating most financial transactions.

The locations so determined are finally located with reference to the terrestrial landscape—layer 102, to provide a real-time, real-world location of the activity.

The location process computation is undertaken by the geospatial database computer using location data supplied by the activity process (online transaction, POS or ATM, for instance) and by the mobile network the mobile device is connected to. In each instance, the activity location data is supplied at the inception of the transaction—simultaneously with the location request. Location of the mobile device is then performed by simple lookup, hence very little process time is spent on computation and in view of the pre-stored nature of the data, the only limitation on the processing time of the location process will be communication latency in the network.

The location system of the invention may be implemented separately of the mobile network, thereby enabling operation of the location system by an independent location services provider. It will be appreciated, however, that the location system could also be integrated with the network and operated by the network operator as an integral part of the network.

1. A method of locating a mobile communication device comprising:
in a preparatory process, the step of recording, in a network element data store, data pertaining to a plurality of network elements constituted by communication devices capable of communicating with the mobile device in a device location process, including the identity and geospatial location of each network element; and
in a process of locating the mobile communication device, the steps of:
communicating, from the mobile device, with one or more network elements located in the vicinity of the mobile device;
determining the identity of each such network element; and
looking up, in the network element data store, the geospatial location of each identified network element, thereby to locate the mobile communication device in the vicinity of the network element.

2. The method of claim 1 including the steps of:
in a supplemental preparatory process, recording, in a transaction device data store, data pertaining to a plurality of transaction devices constituted by devices capable of conducting financial transactions, including the identity and geospatial location of each transaction device;
in response to a location verification request originating from a transaction conducted on a transaction device, implementing a location process including the steps of:
determining the identity of the originating transaction device;
looking up, in the transaction device data store, the geospatial location of the originating transaction device;
querying the network to determine the identity of one or more network elements located in the vicinity of the mobile device;
determining the identity of each such network element;
looking up, in the network element data store, the geospatial location of each identified network element; and
comparing the geospatial location of the transaction device, with the geospatial location of the mobile device, as determined in the first location process.

3. The method of claim 2 in which the geospatial location data pertaining to the network elements and the transaction devices are stored in a digital map in a polygon mesh format, the method including the steps of:
determining the location of the originating transaction device with reference to a map polygon;
digitally locating the mobile device in a map polygon with reference to network elements in the vicinity of the mobile device; and
determining the proximity or otherwise of the map polygons of the originating transaction device and the mobile device.

4. A system for locating a mobile communication device, the system comprising:
a network element data store containing data pertaining to a plurality of network elements constituted by communication devices capable of communicating with the mobile device in a device location process, including data pertaining to the identity and the geospatial location of each network element;
means to determine the identity of each such network element; and
programmable logic means programmed to look up, in the data store, the geospatial location of each identified network element thereby to locate the mobile communication device in the vicinity of the network element.

5. The system of claim 4, including a transaction device data store containing data pertaining to a plurality of transaction devices, which data includes data pertaining to the identity and the geospatial location of each transaction device, the system programmable logic means being programmed:
to receive a location verification request originating from a transaction conducted on a transaction device;
on receipt of a location verification request, to determine the identity of the originating transaction device;
to look up, in the transaction device data store, the geospatial location of the originating transaction device; and
to compare the geospatial location of the transaction device with the geospatial location of each identified network element thereby to locate the mobile communication device.

6. The system of claim 4 in which the system programmable logic means is programmed to store the geospatial location data pertaining to the network elements and the transaction devices in a digital map in a polygon mesh format, the programmable logic means being programmed:
to determine the location of an originating transaction device with reference to a map polygon;
digitally to locate the mobile device in a map polygon with reference to network elements in the vicinity of the mobile device; and
to determine the proximity to one another of the map polygons of the originating transaction device and the mobile device.

7. The system of claim 4 including, in the network element data store, data pertaining to supplemental network elements.

8. A method of locating a mobile communication device is substantially as described in this specification with reference to the accompanying drawing.

9. A system for locating a mobile communication device substantially as described in this specification with reference to the accompanying drawings.
